(19) United States
(12) Patent Application Publication
(10) Pub. No.: US 2014/0216588 A1
(43) Pub. Date: Aug. 7, 2014

(54) System and Method for Irrigating Liquids Over an Obstacle

(71) Applicant: Chad Tasch, Malone, WI (US)

(72) Inventor: Chad Tasch, Malone, WI (US)

(21) Appl. No.: 13/759,792

(22) Filed: Feb. 5, 2013

(51) Int. Cl. F16L 3/00

(52) U.S. Cl. CPC F16L 3/00
USPC 138/106

(57) ABSTRACT

A system, apparatus, and method for use in liquid fertilizer irrigation to transport liquid fertilizer, such as manure, over an obstacle. A raised pipeline apparatus includes a raised pipeline for transporting liquid fertilizer having a first end and a second end, and a first support structure operably connected to the raised pipeline near the first end and the second support structure operably connected to the raised pipeline near the second end. The first and second support structures suspend the arched pipeline in an upright position so as to enable the transport of liquid fertilizer over the obstacle.

### BACKGROUND

Manure is a valuable resource, particularly as its use as a fertilizer, that oftentimes must be transported from one location to another. For example, manure may be transported from a place of processing or storage to a point of application in a field. Manure irrigation systems are used to transport liquid manure from one location to another, for example, so that the liquid manure can be applied to agricultural croplands. Such transport is often done with a hose, such as a manure drag hose, extended along a ground surface. Moreover, it is often needed to transport other liquids, including but not limited to water, fertilizer mixtures and liquid feeds in remote or rural areas.

In the field of liquid transport and irrigation, problems arise due to obstacles along the path of the irrigation system. For example, difficulties often exist in getting an irrigation line across a county or state road. Prior art transport lines are often run underneath roads, bored into the ground on one side of the road, traveling underneath the road, and emerging on the other side of the road.

### SUMMARY

The present disclosure involves improved systems and methods for increasing the ease and safety of liquid transport, and particularly liquid fertilizer transport, while at the same time reducing cost and meeting more stringent regulations. Prior art systems and methods of liquid and particularly liquid manure or fertilizer transport are difficult, expensive, and impractical because they bore into the ground to run the liquid transport line underneath obstacles. Moreover, more stringent regulations have been enacted that create additional obstacles to roaming liquid transport lines under roads, often right of ways such as rail lines, and bodies of water.

One embodiment relates to a raised pipeline apparatus for use in liquid irrigation to transport manure, liquid fertilizer or other liquid over an obstacle having a raised pipeline for transporting the liquid, the raised pipeline having a first end and a second end. The raised pipeline apparatus further has a first support structure operably connected near the first end f o the raised pipeline and a second support structure operably connected near the second end of the raised pipeline. The first and second support structures raise or suspend the raised pipeline in an upright position over an obstacle, enabling liquid transport over the obstacle.

Another embodiment relates to a liquid fertilizer irrigation system comprising a pipeline having an entrance end and an exit end, and a raised pipeline section positioned therebetween. The liquid fertilizer irrigation system further has a first support structure operably connected to the pipeline near a first end of the raised pipeline section and a second support structure operably connected to the manure pipeline near a second end of the raised pipeline section. The first support structure and the second support structure operate to raise or suspend a pipeline section in an upright position over an obstacle so as to enable the transport of liquid fertilizer through the pipeline over or around the obstacle.

Yet another embodiment relates to a method for transporting liquid fertilizer over and obstacle comprising the steps of accessing a supply of liquid fertilizer and pumping the liquid fertilizer into an entrance end of a first hose. The liquid fertilizer gets pumped through the first pipeline section to a raised pipeline that extends over an obstacle. The method may further comprise transporting the liquid fertilizer over the obstacle via the raised pipeline to a second hose. The liquid fertilizer may then be transported through the second hose to an applicator. In one embodiment the liquid fertilizer is liquid manure.

Other principle features and advantages of the presently disclosed system, apparatus, and method will become apparent to those skilled in the art upon review of the following drawings, the detailed description, and the appended claims.

Various other features, objects and advantages of the invention will be made apparent from the following description taken together with the drawings.

### BRIEF DESCRIPTION OF THE DRAWINGS

The drawings furnished herewith illustrate one or more embodiments of the present invention in which the above advantages and features are disclosed, as will be understood from the following description of the illustrated embodiment(s).

FIG. 1 depicts an embodiment of a liquid irrigation system for irrigating manure over an obstacle.

FIG. 2 depicts an embodiment of a raised pipeline apparatus for irrigating liquid over an obstacle.

FIG. 3 depicts an embodiment of a support structure portion of the embodiment of the apparatus depicted in FIG. 2.

FIG. 4 depicts a perspective view of the embodiment of the support structure depicted in FIGS. 2 and 3.

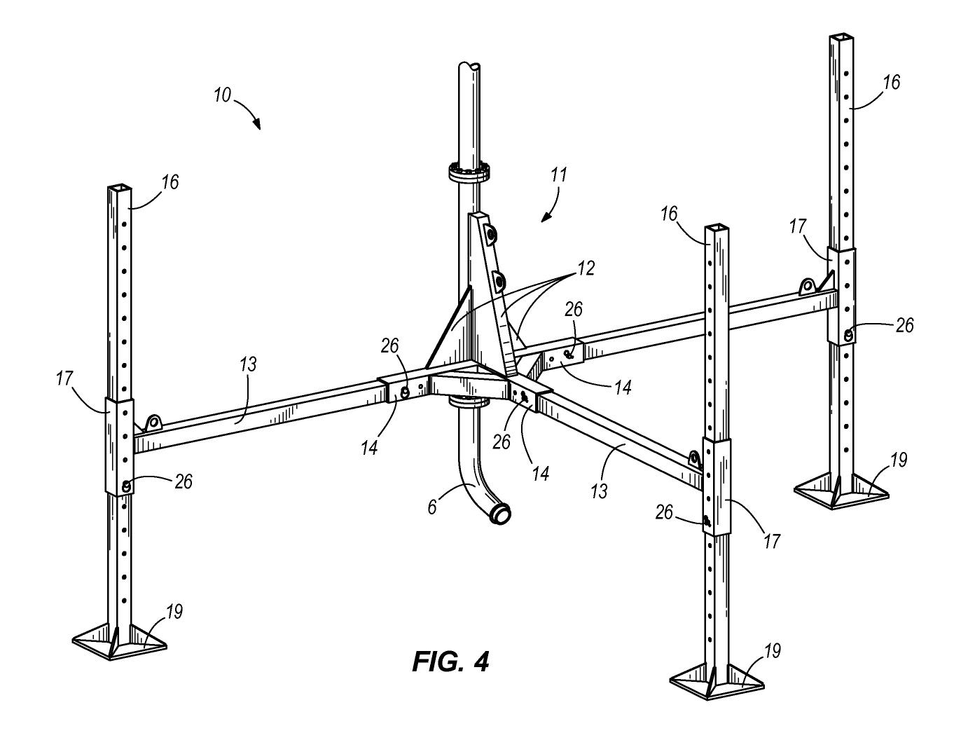

### DETAILED DESCRIPTION OF THE DRAWINGS

In the present description, certain terms have been used for brevity, clarity, and understanding. No necessary limitations are to be implied therefrom beyond the requirements of the prior art and/or the plain meaning of the language or terms used because such language and/or terms are used for descriptive purposes only and are not intended to be broadly construed. The systems, apparatuses, and methods described herein may be used alone or in combination with other systems, apparatuses, and/or methods. Various equivalents, alternatives, and modifications are possible within the scope of the appended claims. None of the limitations the appended claims are intended to invoke interpretation under 35 USC §112, sixth paragraph, unless the terms “means” or “step for” are explicitly recited in the respective limitation.

As will be recognized by one of skill in the art, the present application can be utilized for many liquids, and is particularly adapted for the use of transporting liquid fertilizers. While the detailed description discusses irrigation of liquid manure, it must be recognized that other liquids and other liquid fertilizers may be transported by the disclosed apparatus and materials.

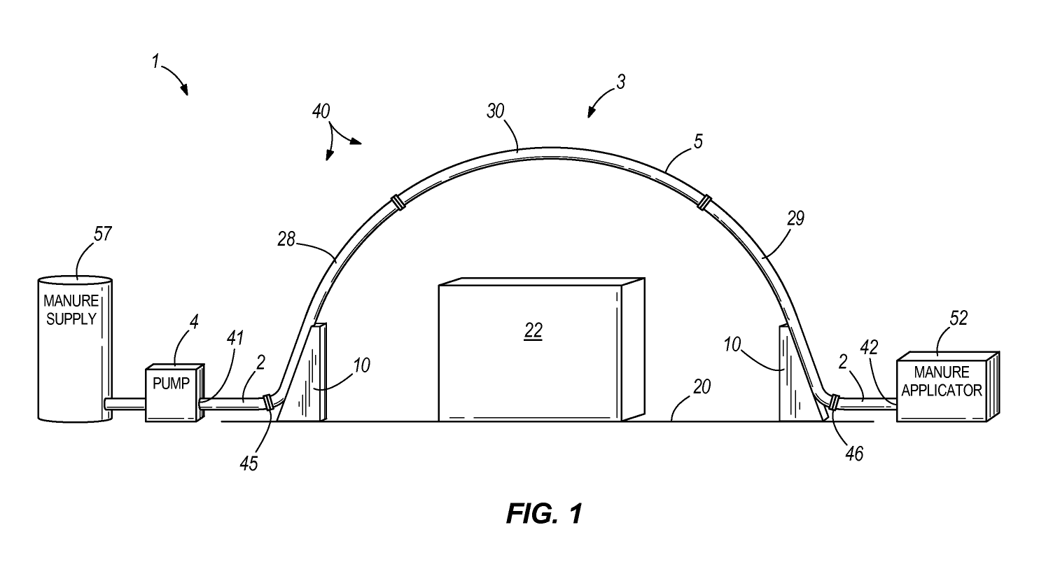

Referring to FIG. 1, one embodiment of a manure irrigation system 1 includes a manure pipeline 40 comprised of one or more ground pipeline sections 2 connected to a raised pipeline apparatus 3. For example, the manure pipeline 40 may connect between a storage container 51 holding liquid manure to a manure applicator 52, such as a manure spreader on a crop field. The manure irrigation system 1 may include a pump 4 for forcing manure through the manure pipeline 40 from an entrance end 41 to an exit end 42 of the manure pipeline 40. One benefit contemplated by the present manure irrigation system 1 is that only one pump may be needed to force manure through the entire manure pipeline 40, including the raised pipeline 5 section. However, in further embodiments, the manure irrigation system 1 may include additional pumps placed at any location along the manure pipeline 40 and configured to assist in transporting manure trough the manure pipeline 40.

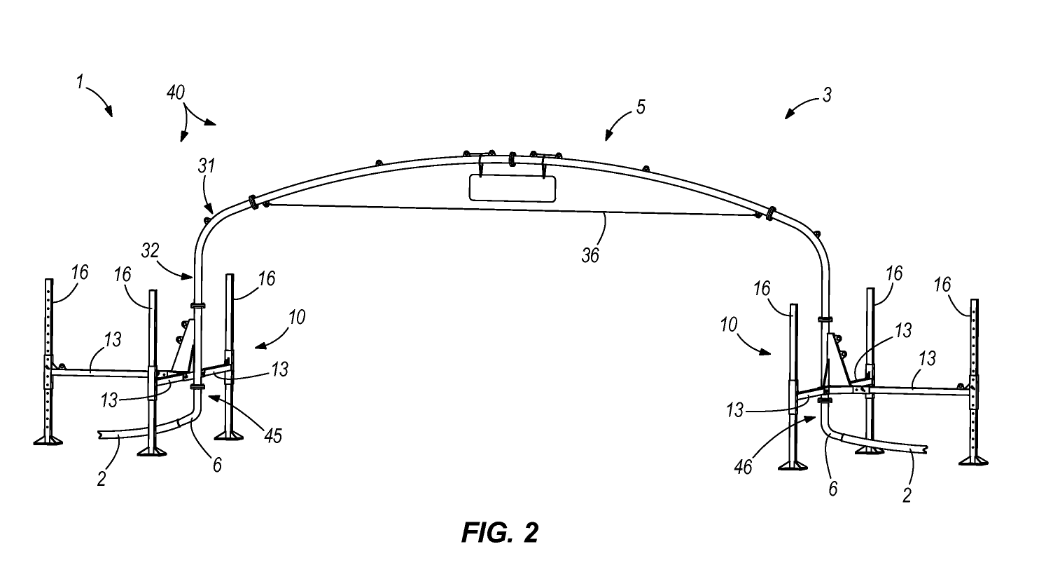

The raised pipeline apparatus 3 is designed to provide an irrigation pathway over an obstacle 22, such as a road, railway, or body of water, such as a stream or river. The raised pipeline apparatus 3 may comprise a raised pipeline 5 having a first end 45 and a second end 46 each configured to attach to other pipeline sections or parts of the manure irrigation system 1. The raised pipeline 5 may form a smooth arch shape, or it may have more of a rectangular shape like the embodiment depicted in FIG. 2, or any other shape that allows for the pipeline to be raised over an obstacle 22 in a bridged fashion.

The raised pipeline 5 of the raised pipeline apparatus 3 may connect at either end. to further pipeline sections that extend along a ground surface 20, such as in the embodiment depicted in FIG. 1. The ground pipeline section(s) 2 of the manure pipeline 40 may extend for a distance along a ground surface 20, for example to transport manure from a manure supply 51 to a manure applicator 52 in a crop field. Thus, depending on the distance of transport, the ground pipeline sections 2 of the manure pipeline may range in length from a few feet to several miles. The ground pipeline sections 2 may be any combination of rigid pipes, such as metal pipes, and/or non-rigid pipes, such as hoses. For example, in one embodiment, the ground pipeline sections 2 are comprised of manure drag hose, and the first end 45 and second end 46 of the arched pipeline 5 have a hose connector 6 configured to connect to the manure drag hoses.

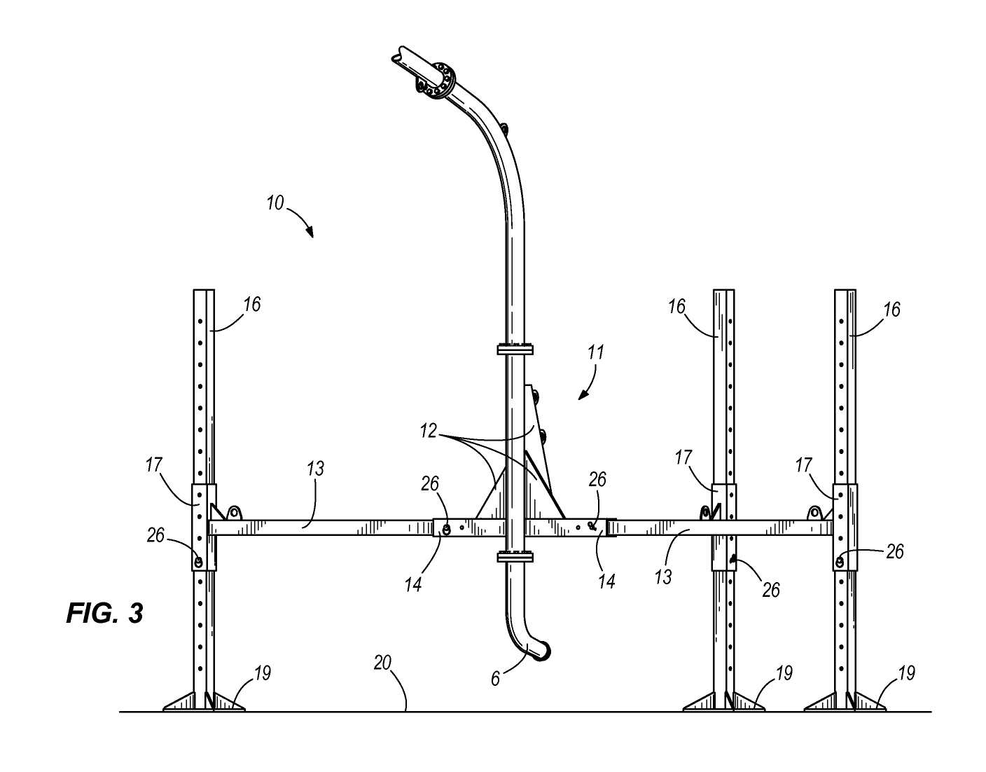

A support structure 10 is operably connected near each end of the raised pipeline 5 in order to support and maintain the raised pipeline 5 in an upright position. The support. structure 10 may include legs 16 attached to a min support body, such as the support connector depicted in FIG. 3, that then attaches to the raised pipeline 5. Alternatively, the support structure may include only legs 16 that connect directly to the raised pipeline 5. In other embodiments, the support connector may comprise any structure that connects directly or operatively to the raised pipeline in order to support the raised pipeline 5 in an upright position over an obstacle 22.

In the embodiment depicted in FIG. 2, the support structure 10 is a tripod having three legs 16 that operably connect to the raised pipeline 5 and extend to a ground surface, thereby maintaining the raised pipeline 5 in an upright position. The support structure 10 may be adjustable so that the raised pipeline 5 can be raised or lowered to accommodate obstacles 22 of differing heights. Additionally, the adjustable support structure 10 could be operable to accommodate uneven ground surfaces. For example, one or more of the legs 16 of the support structure 10 may be adjustable in length.

In an embodiment depicted in FIGS. 2 and 3, the support structure 10 may have a support connector 11 that creates an operable connection between the arched pipeline 5 and the legs 16. The support connector 11 must be strong enough to support the load of the raised pipeline 5 and maintain the raised pipeline 5 in an upright position despite additional forces that may be place on it, for example from weather. Thus, the support connector 11 may have reinforcement beams 12, like those depicted in FIG. 3, that strengthen the support provided by support connector 10 to the raised pipeline 5.

In one embodiment, the one or more legs 16 may extend diagonally from the support connector 11 to the ground surface 20. The diagonal stretching leg, or legs, 16 may be adjustable in length in order to adjust the height of the arched pipeline 5 and/or accommodate a variable ground surface 20 such as a hill or ditch. Alternatively, as depicted in FIGS. 2 and 3, the one or more legs 16 may connect to a horizontal outrigger 13 positioned between the leg 16 to the support connector 11 allowing adjustment of the distance between the leg 16 and the arched pipeline 5, which may add stability to the system. In still other embodiments, one or more legs 16 may have a telescoping structure that allows its height or length to be adjustable.

In the embodiment of the support structure 10 depicted in FIG. 3, the outrigger 13 joins the leg 16 at a leg joint 17. The location of the leg joint 17 is also adjustable to vary the length of the outrigger 13 and/or the position of the leg 16. Specifically, the leg joint 17 may be a T-shaped piece with a horizontal portion connecting to the outrigger 13 and a vertical portion connecting to the leg 16. In one embodiment, the leg joint 17 has a vertical portion that is hollow and configured to accommodate the leg 16 and to adjust up and down the leg 16 in order to allow adjustment of the leg height. The leg joint 17 may be selectably fastened to the leg 16 at various points in order to create a leg 16 of different heights. For example, the leg 16 may have multiple holes along its length which can be aligned with one or more holes in the leg joint 17, to enable the leg joint 17 to be fastened to the leg 16 using a fastener 26, such as clevis pin, rod, screw, or bolt.

In some embodiments, the base of the leg may have a foot 19 that has a wider surface area than that of the bottom of the leg 16 and is configured to provide stability and contact with a ground surface 20. The foot 19 may be fixably attached to the leg 16. Alternatively, the foot 19 may be hingedly attached to the leg 16, such that the angle between the leg 16 and the foot 19 could be adjusted in order to accommodate a slanted or uneven ground surface.

Additionally, the length of the outrigger 13 may be adjustable by adjusting the position of the outrigger 13 with respect to the support connector 11 and/or the leg 16. Specifically, the support connector may have an outrigger joint 14 that may slidably connect to the outrigger 13, wherein the outrigger can slide into the outrigger joint 14 such that the functional length of the outrigger 13 can be adjusted. Alternatively or additionally, the functional length of the outrigger 13 could be adjusted at leg joint 17, wherein the outrigger 13 selectably connected to the leg joint 17 at various points. The joint connections described herein may be through any method known in the art, including the hole and fastener 26 system described above. Alternatively or additionally, the outrigger 13 may have a telescoping structure that allows its length to be adjustable.

The raised pipeline 5 may form any shape that is conducive to transporting liquid fertilizers, such as manure, over an object. The raised pipeline 5 may compose a rigid pipe, non-rigid pipe or any structure for holding a manure hose in a raised position over an obstacle 22, such as a brace structure or a trough structure. Additionally, the raised pipeline 5 may be formed of a single piece, or of multiple pipe portions, e.g., 28-32, connected together to form the raised pipeline 5. As depicted in the example of FIG. 2, straight pipe portions 32 may extend generally perpendicularly from the ground surface 20 and connect to curved pipe portions 31 that curve and/or extend predominantly in the horizontal direction. Alternatively, the raised pipeline 5 could have a continuous curve shape, and could be formed of multiple pipe portions having the same or various curve radiuses, e.g., 28-30 of FIG. 1. In still other embodiments, the raised pipeline 5 may be formed from any combination of straight and/or curved pipe portions, and may form any shape, including triangular, rectangular, or other polygonal shape.

In one embodiment, the raised pipeline apparatus 3 is designed to provide an irrigation path over an obstacle 22 that is a road. In this embodiment, the clearance distance under the raised pipeline apparatus 3 must be wide enough and tall enough to allow vehicles traveling the road to safely pass underneath. For example, the support structures 10 of the bridged pipeline apparatus 3 must be placed far enough apart so that they do not impede any traffic traveling on the road or the shoulder of the road. The support structures 10 on either side of the arched pipeline 5 may be configured to be at least 65 feet apart, meaning that the horizontal distance between the first end 45 and the second end 46 of the arched pipeline 5 is at least 65 feet. Likewise, the raised pipeline apparatus 3 must be tall enough to provide vertical clearance for traffic to pass underneath the manure pipeline. In such embodiments, the raised pipeline 5 may provide at least 14 feet of clearance, if not more, for the entire section over the road. As depicted in FIG. 1, the raised pipeline 5 may have a clearance line 36 attached thereto. The clearance tine 36 attaches to the arched pipeline 5 at the points above the edges of the road, and thereby provides a marker for the clearance height of the arched pipeline 5 over the full width of the road.

Referring again to FIG. 1, a method of transporting and/or irrigating manure may include accessing a liquid manure supply 51, such as a manure storage device or a manure processing device, and pumping the liquid manure into an entrance end of a manure pipeline 40, such as into an entrance end of a ground pipeline section 2 which may be comprised of manure hose, and transporting the liquid manure through manure pipeline 40 to a raised pipeline 5 section thereof. The method further includes transporting the manure through the raised pipeline 5 section, such as may be part of the raised or bridged pipeline apparatus 3 described above. Thereby, liquid manure may be transported up and over the obstacle 22 via the raised pipeline 5 section to a second ground pipeline section 2, such as a second manure hose. The liquid manure is then transported through the remainder of the manure pipeline 40 to a manure applicator, such as systems designed to spread manure to fertilize fields.

The step of transporting the liquid manure over the obstacle 22 through the raised pipeline 5 may further include transporting the manure up through a first pipe portion 28 extending at least partially in the upward direction, away from the ground surface 20. Then, the liquid manure may be transported back down through a second pipe line section 29 extending at least partially in the downward direction towards the ground surface 20. The liquid manure may be further transported through additional sections, such as through a third pipe portion 30 that may be connected between the first pipe portion 28 and second pipe portion 29. As described above, any of the pipe portions may be curved or straight, rigid or non-rigid.

The step of transporting may be accomplished through the use of one or more pumps, and it is further contemplated that gravitational forces may aid the transporting of the liquid manure through the raised pipeline apparatus, particularly once a pump forces the liquid manure to a topmost point in the system as the liquid manure makes its way down towards the second end 46 of the raised pipeline 5.

This written description uses examples to disclose the invention, including the best mode, and also to enable any person skilled in the art to make and use the invention. The patentable scope of the invention is defined by the claims, and may include other examples that occur to those skilled in the art based on the present disclosure. Such other examples are intended to be within the scope of the claims if they have structural elements that do not differ from the literal language of the claims, or if they include equivalent structural elements with insubstantial differences from the literal language of the claims.

I claim:

1. A raised pipeline apparatus for use in transporting liquid over an obstacle, comprising:
a raised pipeline having a first end and a second end; and
a first support structure operably connected to the raised pipeline near the first end and a second support structure operably connected to the raised pipeline near the second end,
wherein the first and second support structures suspend the raised pipeline in an upright position so as to enable the transport of liquid over an obstacle.

2. The pipeline apparatus of claim 1, wherein at least one of the first or second support structure is a tripod having three legs operably extending to a ground surface.

3. The pipeline apparatus of claim 2, wherein at least one of the legs is adjustable in length.

4. The pipeline apparatus of claim 1, wherein the raised pipeline forms a continuous curve shape.

5. The pipeline apparatus of claim 1, wherein the raised pipeline forms three sections, a first and a second section extending primarily in the vertical direction and operably connected by a third section that extends primarily in the horizontal direction.

6. The pipeline apparatus of claim 1, wherein the raised pipeline is formed of two or more rigid pipe portions.

7. The pipeline apparatus of claim 6, wherein the raised pipeline is formed of a curved pipe portion operably connected between two straight pipe portions, wherein the straight pipe portions extend vertically relative to a ground surface.

8. The pipeline apparatus of claim 7, wherein the straight pipe portions each operably connect to one of the first and second support structures.

9. The pipeline apparatus of claim 1, wherein the obstacle is a road, railway or body of water and the liquid is liquid fertilizer.

10. The pipeline apparatus of claim 1, wherein the raised pipeline apparatus provides a clearance width of at least 45 feet and a clearance height of at least 14 feet above a ground surface.

11. The pipeline apparatus of claim 1, wherein the raised pipeline supports a hose.

12. The pipeline apparatus of claim 1, wherein the raised pipeline is formed of at least one rigid portion, and wherein at least one of the first end and the second end of the raised pipeline is configured to attach to a ground pipeline.

13. The pipeline apparatus of claim 12, wherein the raised pipeline is also formed of at least one non-rigid portion.

14. A liquid fertilizer irrigation system, comprising:
a pipeline having an entrance end and an exit end and a raised pipeline section therebetween;
the pipeline further comprising a first support structure operably connected to the pipeline near a first end of the raised pipeline section and a second support structure operably connected to the pipeline near a second end of the raised pipeline section,
wherein the first support structure and the second support structure suspend the arched pipeline section of the pipeline in an upright position over an obstacle so as to enable transport of liquid fertilizer through the pipeline over the obstacle.

15. The liquid fertilizer pipeline system of claim 14, wherein the raised pipeline section of the pipeline is connected between two ground pipeline sections.

16. The liquid fertilizer pipeline system of claim 14, wherein the raised pipeline section is comprised of at least two rigid pipe portions connected together.

17. The liquid fertilizer pipeline system of claim 16, wherein the raised pipeline section is formed of a curved pipe portion operably connected between two straight pipe portions, wherein the two straight pipe portions extend vertically relative to a ground surface.

18. The liquid fertilizer pipeline system of claim 14, further comprising a pump positioned near the entrance end of the pipeline, wherein the pump is configured to pump liquid through the pipeline.

19. The liquid fertilizer pipeline system of claim 14, further comprising a liquid fertilizer applicator positioned at the exit end of the pipeline.

20. The liquid fertilizer pipeline system of claim 14, wherein at east a portion of the pipeline is rigid.

21. The liquid fertilizer pipeline of claim 14, wherein at least a portion of the pipeline is non-rigid.

22. The liquid fertilizer pipeline system of claim 15, wherein the raised pipeline portion is rigid and at least one of the two ground pipeline sections is non-rigid.

23. The liquid fertilizer pipeline system of claim 14, wherein the liquid fertilizer is liquid manure.

24. A method for transporting liquid fertilizer over an obstacle, comprising the steps of:
accessing a supply of liquid fertilizer;
pumping the liquid fertilizer into an entrance end of a first hose;
transporting the liquid fertilizer through a first hose to a raised pipeline that extends over an obstacle;
transporting the liquid fertilizer over the obstacle through the raised pipeline to a second hose; and
transporting the liquid fertilizer through the second hose to an applicator.

25. The method of claim 24 wherein the step of transporting the liquid fertilizer over the obstacle through the raised pipeline further includes the steps of:
transporting the liquid fertilizer up through a first pipe extending at least partially in the upward direction and is supported by a first support structure;
transporting the liquid fertilizer down through a second pipe portion extending at least partially in the downward direction and is supported by a second support structure.

26. The method of claim 25 wherein the step of transporting the liquid fertilizer over the obstacle through the raised pipeline section further includes the step of:
transporting the liquid fertilizer through a third pipe portion connected between the first and second raised pipeline sections and extending at least partially in the horizontal direction.

27. The method of claim 26, wherein the liquid fertilizer is liquid manure.
